(19) United States
(12) Patent Application Publication
(10) Pub. No.: US 2019/0186930 A1
(43) Pub. Date: Jun. 20, 2019

(54) A METHOD, APPARATUS AND COMPUTER PROGRAM PRODUCT FOR ASSISTING A USER IN LOCATING A VEHICLE

(71) Applicant: NOKIA TECHNOLOGIES OY, Espoo (FI)

(72) Inventors: Yue CHEN, Beijing (CN); Yuyang LIANG, Beijing (CN); Peng LAN, Beijing (CN); Rui YU, Beijing (CN)

(73) Assignee: NOKIA TECHNOLOGIES OY, Espoo (FI)

(21) Appl. No.: 16/327,947

(22) PCT Filed: Aug. 26, 2016
(86) PCT No.: PCT/CN2016/096895

§ 371 Date: Feb. 25, 2019

(51) Int. Cl. G01C 21/34; G08G 1/005; G08G 1/00; G06Q 10/02; G06Q 50/30; G07C 5/00

(52) U.S. Cl. CPC G01C 21/3438; G08G 1/005; G07C 5/008; G06Q 10/02; G06Q 50/30; G08G 1/202

(57) ABSTRACT

A method, apparatus and computer program product are provided for assisting a user in locating and/or identifying a vehicle that a user has requested. In some examples, the vehicle may be a self-driving or autonomous car. In some examples, the vehicle may not necessarily arrive at the exact location requested by the user, but may be in close proximity to the requested location. Location information of the vehicle, such as a detected real-time location, photographs of the environment surrounding the vehicle, and/or directions to the vehicle may be provided to the user who has requested the vehicle. The user may then efficiently identify the vehicle that was sent for pickup. A key may be associated with the pickup request. The assigned vehicle may communicate the key to the user, for example, by flashing a series of lights indicative of the key, so that the user can identify the vehicle.

### TECHNOLOGICAL FIELD

An example embodiment of the present invention relates generally to user interfaces, and more particularly, to a method, apparatus and computer program product for assisting a user in locating a vehicle that a user has requested for pickup.

### BACKGROUND

Many people use taxis, ride-sharing programs, or private driving services, such as Uber®, Lyft®, and/or the like to request a ride or pickup from a specified location. In many instances, an individual or group may request a ride via a mobile device or other user device. In some situations, the user may have difficulty in identifying the vehicle once it has arrived in the vicinity of the pickup. For example, in some instances, the user may request a pickup in a pedestrian area or other area the vehicle cannot access. Or, a user may request pickup at a large commercial building, where many pickup locations or exits are available. In such scenarios, it may be difficult for a user to provide an exact address. As another example, many users may request a ride after leaving a large event, causing disagreements between parties as to which vehicle is intended for which rider(s).

In some examples, a driver of the vehicle could communicate with the user, either electronically, by phone, or in person upon arrival. However, with the advent of autonomous and self-driving vehicles, further complications are introduced. If no driver is present, it may be even more difficult for the user identify the correct vehicle. Confusion as to which vehicle to approach and enter may further lead to safety concerns for the riders.

### BRIEF SUMMARY

A method, apparatus, and computer program product are therefore provided for assisting a user in locating and/or identifying a vehicle that a user has requested. Example embodiments provide a service for facilitating a driving service that receives a pickup request from users and assigns the pickup request to a vehicle to pick up the user. In some examples, the vehicle may be a self-driving or autonomous car. In some examples, the vehicle may be unable to arrive at the exact location requested by the user, but may be in close proximity for the user to walk to and locate. Location information of the vehicle, such as a detected real-time location, photographs of the environment surrounding the vehicle, and/or directions from the user's mobile device to the vehicle may be provided to the user who has requested the vehicle. The user may then efficiently identify the vehicle that was sent for pickup. In some examples, a unique key may be associated with the pickup request. The assigned vehicle may communicate the unique key to the user, for example, by flashing a series of lights indicative of the unique key, so that the user can identify the vehicle.

An apparatus is provided, comprising at least one processor and at least one memory including computer program code, the at least one memory and the computer program code configured to, with the processor, cause the apparatus to at least: receive a pickup request indication, wherein the pickup request indicates a request for pickup of a user by a vehicle at a pickup location; receive an arrival indication, wherein the arrival indication indicates the vehicle has arrived for the pickup; in response to the arrival indication, determine location information of the vehicle; and cause provision of the location information of the vehicle on a user device.

In some embodiments, the at least one memory and the computer program code are further configured to cause the apparatus to at least generate a key associated with the pickup request; and cause the vehicle to communicate the key, such as by causing the vehicle to flash light in at least one of a pattern or color associated with the key and the pickup request.

A computer program product is provided, the computer program product comprising at least one non-transitory computer-readable storage medium having computer-executable program code instructions stored therein, the computer-executable program code instructions comprising program code instructions to cause the apparatus to at least: receive a pickup request indication, wherein the pickup request indicates a request for pickup of a user by a vehicle at a pickup location; receive an arrival indication, wherein the arrival indication indicates the vehicle has arrived for the pickup; in response to the arrival indication, determine location information of the vehicle; and cause provision of the location information of the vehicle on a user device.

In some embodiments, the computer-executable program code instructions further comprise program code instructions to generate a key associated with the pickup request; and cause the vehicle to communicate the key, such as by causing the vehicle to flash light in at least one of a pattern or color associated with the key and the pickup request.

A method is provided, the method comprising receiving a pickup request indication, wherein the pickup request indicates a request for pickup of a user by a vehicle at a pickup location; receiving an arrival indication, wherein the arrival indication indicates the vehicle has arrived for the pickup; in response to the arrival indication, determining location information of the vehicle; and causing provision of the location information of the vehicle on a user device.

In some embodiments, the method further comprises generating a key associated with the pickup request; and causing the vehicle to communicate the key, such as by causing the vehicle to flash light in at least one of a pattern or color associated with the key and the pickup request.

An apparatus is provided, the apparatus comprising: means for receiving a pickup request indication, wherein the pickup request indicates a request for pickup of a user by a vehicle at a pickup location; means for receiving an arrival indication, wherein the arrival indication indicates the vehicle has arrived for the pickup; means for, in response to the arrival indication, determining location information of the vehicle; and means for causing provision of the location information of the vehicle on a user device.

In some embodiments, the apparatus further comprises means for generating a key associated with the pickup request; and means for causing the vehicle to communicate the key, such as by causing the vehicle to flash light in at least one of a pattern or color associated with the key and the pickup request.

In some embodiments, the location information of the vehicle comprises any of a detected real-time location of the vehicle determined by a global navigation satellite system (GNSS), at least one photograph captured from the vehicle, and/or directions from a user device location to the vehicle.

In some embodiments, the key is communicated in response to determining the user device is approaching the vehicle and/or the vehicle is approaching the user device. In some examples, the light flashed by the vehicle is based on ambient conditions. And, in some examples, the pickup request indication is received and processed by a server, and the location information of the vehicle is transmitted from the server to the user device.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus that may be configured to implement example embodiments of the present invention;

FIG. 2 is a block diagram of a system that may be configured to utilize an apparatus according to example embodiments of the present invention; and

FIG. 3 is a flowchart illustrating operations performed in accordance with example embodiments of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

As described below, a method, apparatus and computer program product are provided for assisting a user in identifying and locating a vehicle, in a scenario in which the user has requested to be picked up by a vehicle in a given location (e.g., pickup location).

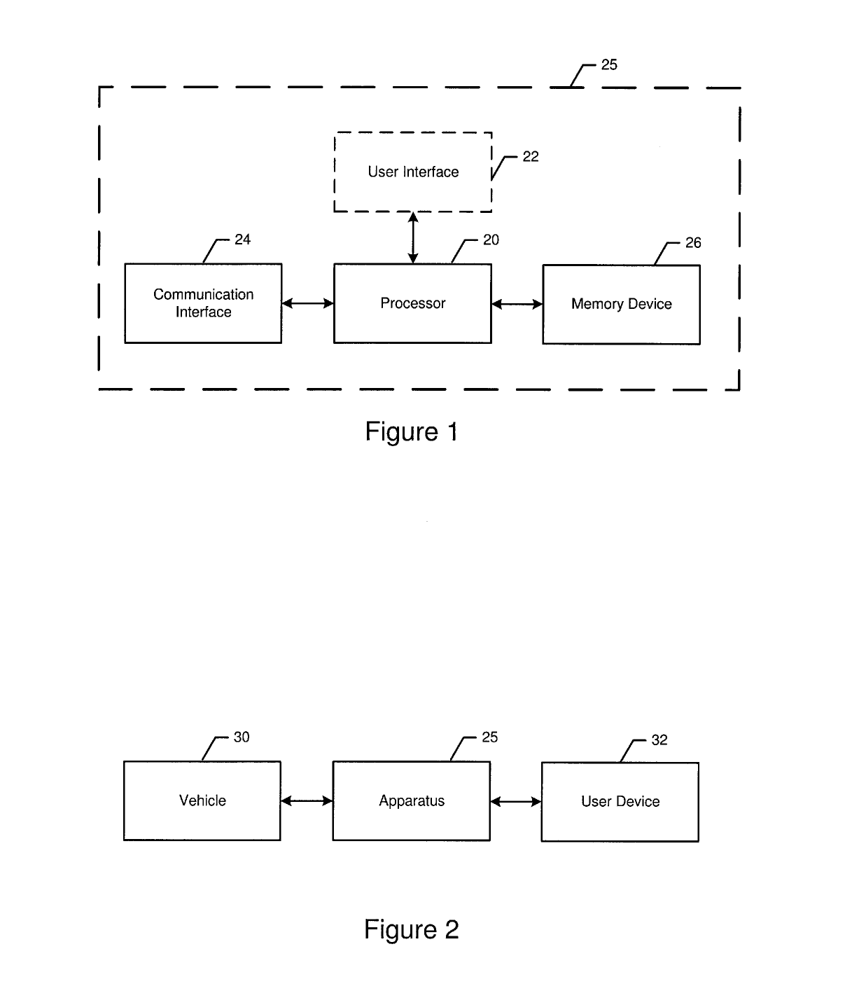

Referring to FIG. 1, apparatus 25 may include or otherwise be in communication with a processor 20, communication interface 24, and memory device 26. As described below and as indicated by the dashed lines in FIG. 1, in some embodiments, the apparatus 25 may also optionally include a user interface 22. Apparatus 25 may be implemented as a server or distributed system, such as a server or centralized system for receiving ride requests (e.g., pickup requests) from users, and distributing and assigning such requests to vehicles and/or drivers to complete the pickup. In some example, apparatus 25 need not necessarily be embodied by a server, and may be embodied by a wide variety of devices including personal computers, work stations, or mobile terminals, such as laptop computers, tablet computers, global positioning system (GPS) devices, navigation devices, or any combination of the aforementioned, and other types of voice and text communications systems. In some example, apparatus 25 may be embodied within a vehicle, including but not limited to a self-driving vehicle.

In some embodiments, the processor 20 (and/or co-processors or any other processing circuitry assisting or otherwise associated with the processor 20) may be in communication with the memory device 26 via a bus for passing information among components of the apparatus 25. The memory device 26 may include, for example, one or more volatile and/or non-volatile memories. In other words, for example, the memory device 26 may be an electronic storage device (e.g., a computer readable storage medium) comprising gates configured to store data (e.g., bits) that may be retrievable by a machine (e.g., a computing device like the processor 20). The memory device 26 may be configured to store information, data, content, applications, instructions, or the like for enabling the apparatus to carry out various functions in accordance with an example embodiment of the present invention. For example, the memory device 26 could be configured to buffer input data for processing by the processor 20. Additionally or alternatively, the memory device 26 could be configured to store instructions for execution by the processor 20.

The apparatus 25 may, in some embodiments, be embodied in various devices as described above. However, in some embodiments, the apparatus 25 may be embodied as a chip or chip set. In other words, the apparatus 25 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 25 may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 26 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., a mobile terminal or network entity) configured to employ an embodiment of the present invention by further configuration of the processor 20 by instructions for performing the algorithms and/or operations described herein. The processor 20 may include, among other things, a clock, an arithmetic logic unit (ALU) and logic gates configured to support operation of the processor 20.

Meanwhile, the communication interface 24 may be any means such as a device or circuitry embodied in either hardware or a combination of hardware and software that is configured to receive and/or transmit data from/to a network and/or any other device or module in communication with the apparatus 25. In this regard, the communication interface 24 may include, for example, an antenna (or multiple antennas) and supporting hardware and/or software for enabling communications with a wireless communication network. Additionally or alternatively, the communication interface 24 may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface 24 may include a communication modem and/or other hardware/software for supporting communication via cable, digital subscriber line (DSL), universal serial bus (USB) or other mechanisms.

In some embodiments, such as instances in which the apparatus 25 is embodied by a user device, the apparatus 25 may include a user interface 22 that may, in turn, be in communication with the processor 20 to receive an indication of a user input and/or to cause provision of an audible, visual, mechanical or other output to the user. As such, the user interface 22 may include, for example, a keyboard, a mouse, a joystick, a display, a touch screen(s), touch areas, soft keys, a microphone, a speaker, or other input/output mechanisms. Alternatively or additionally, the processor 20 may comprise user interface circuitry configured to control at least some functions of one or more user interface elements such as, for example, a speaker, ringer, microphone, display, and/or the like. The processor 20 and/or user interface circuitry comprising the processor 20 may be configured to control one or more functions of one or more user interface elements through computer program instructions (e.g., software and/or firmware) stored on a memory accessible to the processor 20 (e.g., memory device 26, and/or the like). In some embodiments, such as instances in which the apparatus 25 is embodied by a user device, the apparatus 25 may include a camera or other image capturing device, which is configured to capture images, including video images.

FIG. 2 is a block diagram of a system that may be configured to utilize an apparatus, such as apparats 25, according to example embodiments. In some examples, such as those in which apparatus 25 is implemented as a server, apparatus 25 may be implemented remotely from any number of vehicles 30 and user devices 32, and may be configured to communicate with the vehicles 30 and user devices 32 over a network. In this regard, the user device 32 may be in the possession of a user who has requested a vehicle to pick up the user at a specified location. In some examples, however, apparatus 25 may be partially and/or wholly implemented within vehicle 30 and/or user device 32.

In general, apparatus 25 may receive requests from user devices such as user device 32, indicating a pickup location, or location in which the user desires to be picked up. Apparatus 25 may determine a suitable vehicle to be sent to pick up the user, and transmit a notification to the suitable vehicle, such as vehicle 30. Apparatus 25 may determine information to assist the user in locating the vehicle 30, and transmit the information to user device 32 for provision on the user device 32, as described according to the example embodiments provided herein.

Vehicle 30 may comprise a processor, such as processor 20 and/or a communication interface, such as communication interface 24, which may be configured for communicating with apparatus 25 and/or user device 32. In some examples, vehicle 30 may include a memory device, such as memory device 26. In some examples, vehicle 30 may be equipped with a camera (not shown), configured to capture photographs for transmittal to apparatus 25 and/or user device 32, as described in further detail herein after. In some examples, vehicle 30 may be equipped with a global positioning system (GPS), for detecting a real-time location of the vehicle 30 and/or for the apparatus 25 to track the progress of vehicle 30.

User device 32 may be any device configured for use by a user, such as that used to request a vehicle pickup. The user device 32 may therefore include a processor, such as processor 20, communication interface such as communication interface 24, user interface, such as user interface 22, and/or a memory device, such as memory device 26. User device 32 may be embodied by a wide range of devices including personal devices and mobile devices such as a smart phone, personal navigation system, wearable device, and/or the like.

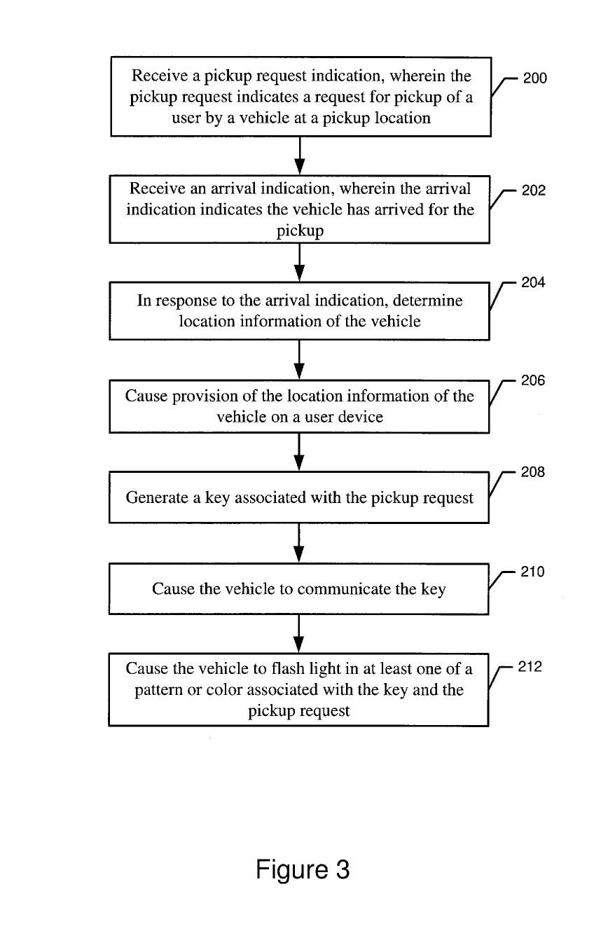

Referring now to FIG. 3, the operations for providing assistance to a user to locate a vehicle are outlined in accordance with an example embodiment. In this regard and as described below, the operations of FIG. 3 may be performed by an apparatus 25.

As shown by operation 200, the apparatus 25 may include means, such as the processor 20, the user interface 22, the communication interface 24 or the like, for receiving a pickup request indication, wherein the pickup request indicates a request for pickup of a user or any object by a vehicle at a pickup location. In this regard, a user of user device 32 may initiate a pickup request via an application or by placing a phone call to an operator, who may place the request via a similar application. In this regard, the pickup request may include any data indicative of a request for the user or any object to be picked up by a vehicle at a specified pickup location. The pickup location may include any information used to identify a location, such as an address, intersection, coordinates, building name, point-of-interest, and/or the like. As another example, the pickup location may be a detected location of the user device 32, such as that determined by a global navigation satellite system (GNSS), for example a global positioning system (GPS) and/or the like. Alternatively or additionally, the location of the user device 32 may be detected by a mobile telecommunication system. Further, the operator may get the location from the mobile telecommunication system. In some alternative or additional embodiments, the pickup location may be different from the user device 32. In this case, the user of the user device 32 can input the different location via the application. Regardless of the means by which the user makes the pickup request, the pickup request may be received by the apparatus 25 for processing.

In some examples, the apparatus 25 may process the request be assessing available vehicle inventory, and assigning the pickup request to a suitable vehicle, such as one in close proximity to the pickup location, or a vehicle selected by the user. In some examples, assigning the pickup request to a vehicle may occur on a separate apparatus from apparatus 25. Regardless of implementation, the request may then be transmitted, such as by apparatus 25 or the like, to vehicle 30. In some embodiments, apparatus 25 may be configured to track the progress of various vehicles to their respective destinations or pickup locations, and manage the routing and dispatching of vehicles and pickup requests accordingly. This may be performed with a GNSS operative in various vehicles, other automated tracking systems, and/or the like.

As shown by operation 202, the apparatus 25 may include means, such as the processor 20, the user interface 22, the communication interface 24 or the like, for receiving an arrival indication, e.g., from the vehicle, wherein the arrival indication indicates the vehicle has arrived for the pickup. In this regard, an indication that the vehicle has arrived for the pickup may not necessarily mean that the vehicle has arrived in the precise pickup location. In some examples, the vehicle may be in close proximity to the pickup location, but it may be impossible, impractical or otherwise difficult for the vehicle to get any closer to the pickup location. For example, the pickup location may be in a forbidden zone or pedestrian-only area. The vehicle may be restricted based on one-way roads, congestion, traffic, or the like. As another example, the pickup location may be at an ambiguous location, such as a commercial or office building with north and south gates, or other various pickup locations.

The arrival indication may be generated by apparatus 25. For example, the vehicle 30 may transmit a GPS or other location information to the apparatus 25 such that apparatus 25, such as with processor 20, determines that the vehicle 30 is in close proximity to the pickup location and/or user device 32 (e.g., within a threshold distance and/or threshold time, such as a half kilometer, or 2 minute walk). Alternatively or additionally, the apparatus 25 may receive location information of the vehicle 30 from a wireless telecommunication system to which the apparatus is communicatively connected. For example, real-time, or near real-time locations of vehicle 30 assigned to the pickup request may be tracked and continuously or repeatedly compared to the associated pickup location. If the vehicle 30 comes within the threshold, e.g. distance, time and/or proximity to the pickup location and/or user device 32, or if the vehicle 30 has been stationary for at least a predetermined threshold of time, for example, the apparatus 25 may generate the arrival indication. Alternatively or additionally, the apparatus 25 may receive location information of the user device 33 from the device itself, for example as a global navigation satellite system location information, or from a wireless telecommunication system to which the device is communicatively connected. This allows the user device 33 to move and still allow the apparatus 25 compare and match the location of the user device 33 to the location of the vehicle 30.

In some examples, the arrival indication may be generated by vehicle 30, and transmitted to apparatus 25 over a network and via communication interface 24. Additionally or alternatively, a driver of vehicle 30 may use a mobile device, navigation system or the like, to indicate that the vehicle 30 has arrived for pickup (e.g., in close proximity to the pickup location). In some examples, a driver of vehicle 30 may indicate to an operator who may otherwise indicate, such as via an application, that the vehicle 30 has arrived near the pickup location. Regardless of implementation, it will be appreciated that the arrival indication need not indicate an arrival at the exact or precise pickup location requested, but that the arrival indication indicates that the vehicle 30 is in a suitable position to which the requesting user can walk or otherwise access.

As shown by operation 204, the apparatus 25 may include means, such as the processor 20, the user interface 22, the communication interface 24 or the like, for, in response to the arrival indication, determining location information of the vehicle. The location information may include any information or data describing the location of the vehicle, such as an actual location, or location relative to the pickup location and/or user device 32. As mentioned above, for example, the location information may include a GPS-detected location of vehicle 30, and/or the location information of the vehicle 30 may be received from the wireless telecommunication system to which the vehicle is communicatively connected.

As yet another example, the location information may include one or more photographs, taken by a camera of vehicle 30. Even in an autonomous car, the vehicle may be equipped with any number of camera(s) configured to take photographs, including panoramic images of the environment surrounding the vehicle. Any number of cameras may be mounted to, affixed to, or built-in to the body of the vehicle 30. Photographs may include a portion of or the entire vehicle 30 for reference. The photographs may include a front view of the vehicle 30, rear view, left view, and/or side view of or from the vehicle 30. The photographs may be taken from any angle of the vehicle 30. As another example, a driver of the car may take one or more photographs with a mobile device or camera and initiate transmittal of the photographs to apparatus 25. The photographs may be considered location information, as the photographs may indicate the location of vehicle 30.

As another example, the location information may comprise directions or navigational information describing a route from the user device 32 and/or pickup location to vehicle 30. For example, apparatus 25, such as with processor 20, may utilize navigational applications to generate a route or directions. The directions may be generated based on a starting point of the last known location of the user device 32, such as that detected by GPS. As another example, the starting point may be considered the pickup location requested by a user.

The location information may include any combination of the examples provided above, including other information indicating the location of the vehicle 30.

Continuing to operation 206, the apparatus 25 may include means, such as the processor 20, the user interface 22, the communication interface 24 or the like, for causing provision of the location information of the vehicle on a user device, such as user device 32. The apparatus 25 may therefore further be configured to transmit the location information to the user device 32. In this regard, any of the location information may be received by the user device 32 and provided to the user via a user interface, such as user interface 22, for example. The user device 32 may provide audial, visual or haptic feedback to indicate the location of the vehicle to the user.

For example, the photographs taken by vehicle 30 of the surrounding environment may be displayed on a display of the user device 32. The user may look at the photographs relative to their surrounding environment to identify the location of the vehicle 30.

As another example, the user device 32 may provide navigational instructions. The directions may be determined based on the user device 32, or pickup location as the starting point. The destination may be considered the actual location of the vehicle 30. In an example embodiment, the apparatus 25 and user device 32 may repeatedly communicate to provide step-by-step or updated directions based on an updated location or movement of the user device 32. The user device 32 may communicate its location to the apparatus 25 for the navigational instructions to update. In some examples feedback may be provided via the user device 32 to indicate whether the user is moving in the right direction to arrive at the vehicle 30. For example, the user device 32 may provide audial feedback, such as verbal instructions. In some embodiments, the user device 32 may provide haptic feedback such as vibrations indicating navigational instructions. In some examples, the photographs of the surrounding environment of the vehicle may be provided when the user device 32 is in close proximity to, such as within a threshold distance of or travel time to the vehicle 30.

As shown by operation 208, the apparatus 25 may include means, such as the processor 20, the communication interface 24 or the like, for generating a key associated with the pickup request. The key may be any form of data used to identify the user requesting pickup, or associated with the pickup request. As an example, the key may be a unique identifier or string associated with the pickup request in the memory device 26 and/or the like. For example, the key may be generated to include or be based on a user identifier or ID, a timestamp of the pickup request, a randomly generated key, and/or the like. The key may be generated by apparatus 25 in response to receiving the pickup request indication. The key may be provided to vehicle 30 and or the user device 32. The key may therefore provide for unique identification of vehicle 30 and/or user device 32, and enable a user to confirm that the vehicle 30 is the intended or assigned vehicle for pickup.

As shown by operation 210, the apparatus 25 may include means, such as the processor 20, the communication interface 24 or the like, for causing the vehicle to communicate the key. The key may be communicated by the vehicle 30 such as via a user interface (e.g., user interface 22). For example as shown by operation 212, the apparatus 25 may include means, such as the processor 20, the communication interface 24 or the like, for causing the vehicle to flash light in at least one of a pattern or color associated with the key and the pickup request. Lights, such as but not limited to light-emitting diode (LED) and/or laser lights, affixed to or emitting from the vehicle 30 may be configured to flash in a pattern and/or project a figure based on the key. The lights may flash with a duration or series of durations according to the key. The duration of pauses between flashes may also be based on the key. The vehicle 30 may be equipped with any number of lights, the flashing of which may occur in a specified pattern according to the key. For example, a vehicle may have six lights in a horizontal configuration. The indication of the key may further include which of the six lights flashes and/or the duration. As another example, multiple lights could be configured in a grid. As yet another example, the lights could be configured to flash in different colors according to the key.

In some examples, the apparatus 25 may direct the vehicle 30 to flash the lights according to ambient conditions. For example, in rainy or foggy weather, the lights may flash brighter or faster relative to the flashing of the lights on a clear day. Additionally or alternatively, colors of the light may be based on the ambient conditions. For example, in foggy weather, white light may not be as recognizable by the user from a distant location as yellow and red light, so apparatus 25 may direct the vehicle 30 to flash lights in colors more visible according to the ambient conditions. Similarly, a single color may not be as visible to the user, so the apparatus 25 may cause emission of a light pattern having various colors. As another example, if the ambient conditions reflect a background color, such as the color of a nearby building, apparatus 25 may cause the light to be emitted in a contrasting color to the background or surrounding area. As another example, if the vehicle is near a building with glass or another surface reflecting sunshine, the lights may be adjusted accordingly so that the light is more visible to a user.

Accordingly, a user in the vicinity of the vehicle 30 may see the flashing lights and identify the vehicle 30 based on the unique key that the user has also received via the user device 32. The key received at the user device 32 may be provided in a similar or same fashion as that provided by the vehicle 30. For example, a display of a user interface, such as user interface 22, may mimic the flashing lights of a vehicle, or lights on the user device 32. As yet another example the user interface 32 may provide some other indication of the key that the user can confirm that the vehicle is the vehicle assigned for their pickup.

In some embodiments, the vehicle 30 and/or user device 32 may communicate the key to the other via near field communication, when the vehicle 30 and user device 32 come within a close range or within threshold distance to communicate by such a method.

As another example of the vehicle 30 communicating the key, the vehicle 30 may be equipped with a display that displays the key. A user near the vehicle may view the display to identify the vehicle. In some embodiments, the vehicle 30 may be equipped with a speaker or similar device to emit sound indicative of the key.

In some examples, the vehicle 30 may communicate the key in response to the arrival indication. As another example, the user device 32 may communicate its position to the apparatus 25 as it approaches the vehicle 30, or as the vehicle 30 approaches the user device 32. In response to the user device 32 arriving within a threshold distance of the vehicle 30, and/or in response to detecting that the user device 32 and vehicle 30 are within a threshold distance of each other, the vehicle 30 may communicate the key.

Regardless of implementation, the key generated by apparatus 25 and transmitted to the vehicle 30 and/or user device 32 may help lead the user to the correct vehicle, and therefore ensures the safety of the user.

The example embodiments provided herein therefore assist a user in identifying a vehicle that was assigned to the user's pickup request. The apparatus 25 may be embodied by a server, such as a centralized system for managing the pickup requests and assignments of the requests to respective vehicles. The apparatus 25 may be further configured to track various vehicles 30 and/or user device(s) 32 and to provide updated routing information and efficient dispatching of vehicles. Causing provision of location information and/or a key via the user device 32 may further assist the user in identifying the vehicle 30 and may improve the safety of private riding systems and/or ride sharing programs.

As described above, FIG. 3 illustrates a flowchart of an apparatus 25, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 26 of an apparatus 25 employing an embodiment of the present invention and executed by a processor 20 of the apparatus 25. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

The method, apparatus 25 and computer program product may be utilized in various scenarios and implementations. The apparatus 25 may be implemented within vehicle 30 or user device 32, or as in some examples, may be embodied by a server configured to communicate with vehicle 30 and user device 32. In this regard, the pickup request may be received and processed by apparatus 25, and the location information of the vehicle may be transmitted from the apparatus 25 to the user device 32.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to at least:
receive a pickup request indication, wherein the pickup request indicates a request for pickup of a user by a vehicle at a pickup location;
receive an arrival indication, wherein the arrival indication indicates the vehicle has arrived for the pickup;
in response to the arrival indication, determine location information of the vehicle; and
cause provision of the location information of the vehicle on a user device.

2. The apparatus according to claim 1, wherein the location information of the vehicle comprises a detected real-time location of the vehicle determined by a global navigation satellite system (GNSS).

3. The apparatus according to claim 1, wherein the location information of the vehicle comprises at least one photograph captured from the vehicle.

4. The apparatus according to claim 1, wherein the location information of the vehicle comprises at least one photograph of surroundings of the vehicle, captured by the vehicle.

5. The apparatus according to claim 1, wherein the location information of the vehicle comprises at least directions from a user device location to the vehicle.

6. The apparatus according to claim 1, wherein the at least one memory and the computer program code are further configured to cause the apparatus to at least:
generate a key associated with the pickup request; and
cause the vehicle to communicate the key.

7. The apparatus according to claim 6, wherein the at least one memory and the computer program code are further configured to cause the apparatus to at least:
cause the vehicle to flash light in at least one of a pattern or color associated with the key and the pickup request.

8. The apparatus according to claim 7, wherein the light flashed by the vehicle is based on ambient conditions.

9. The apparatus according to claim 6, wherein the key is communicated in response to determining the user device is approaching the vehicle.

10. The apparatus according to claim 6, wherein the key is communicated in response to determining the vehicle is approaching the user device.

11. The apparatus according to claim 1, wherein the pickup request indication is received and processed by a server, and the location information of the vehicle is transmitted from the server to the user device.

12. A computer program product comprising at least one non-transitory computer-readable storage medium having computer-executable program code instructions stored therein, the computer-executable program code instructions comprising program code instructions to:
receive a pickup request indication, wherein the pickup request indicates a request for pickup of a user by a vehicle at a pickup location;
receive an arrival indication, wherein the arrival indication indicates the vehicle has arrived for the pickup;
in response to the arrival indication, determine location information of the vehicle; and
cause provision of the location information of the vehicle on a user device.

13. The computer program product according to claim 12, wherein the location information of the vehicle comprises a detected real-time location of the vehicle determined by a global navigation satellite system (GNSS).

14. The computer program product according to claim 12, wherein the location information of the vehicle comprises at least one photograph captured from the vehicle.

15. The computer program product according to claim 12, wherein the location information of the vehicle comprises at least one photograph of surroundings of the vehicle, captured by the vehicle.

16. The computer program product according to claim 12, wherein the location information of the vehicle comprises at least directions from a user device location to the vehicle.

17. The computer program product according to claim 12, wherein the computer-executable program code instructions further comprise program code instructions to:
generate a key associated with the pickup request; and
cause the vehicle to communicate the key.

18. The computer program product according to claim 17, wherein the computer-executable program code instructions further comprise program code instructions to:
cause the vehicle to flash light in at least one of a pattern or color associated with the key and the pickup request.

19. The computer program product according to claim 18, wherein the light flashed by the vehicle is based on ambient conditions.

20. The computer program product according to claim 17, wherein the key is communicated in response to determining the user device is approaching the vehicle.

21. The computer program product according to claim 17, wherein the key is communicated in response to determining the vehicle is approaching the user device.

22. The computer program product according to claim 12, wherein the pickup request indication is received and processed by a server, and the location information of the vehicle is transmitted from the server to the user device.

23. A method comprising:
receiving a pickup request indication, wherein the pickup request indicates a request for pickup of a user by a vehicle at a pickup location;
receiving an arrival indication, wherein the arrival indication indicates the vehicle has arrived for the pickup;
in response to the arrival indication, determining location information of the vehicle; and
causing provision of the location information of the vehicle on a user device.

24. The method according to claim 23, wherein the location information of the vehicle comprises a detected real-time location of the vehicle determined by a global navigation satellite system (GNSS).

25. The method according to claim 23, wherein the location information of the vehicle comprises at least one photograph captured from the vehicle.

26. The method according to claim 23, wherein the location information of the vehicle comprises at least one photograph of surroundings of the vehicle, captured by the vehicle.

27. The method according to claim 23, wherein the location information of the vehicle comprises at least directions from a user device location to the vehicle.

28. The method according to claim 23, further comprising:
generating a key associated with the pickup request; and
causing the vehicle to communicate the key.

29. The method according to any of claim 28, further comprising:
causing the vehicle to flash light in at least one of a pattern or color associated with the key and the pickup request.

30. The method according to claim 29, wherein the light flashed by the vehicle is based on ambient conditions.

31. The method according to claim 28, wherein the key is communicated in response to determining the user device is approaching the vehicle.

32. The method according to claim 28, wherein the key is communicated in response to determining the vehicle is approaching the user device.

33. The method according to claim 23, wherein the pickup request indication is received and processed by a server, and the location information of the vehicle is transmitted from the server to the user device.

34. (canceled)

35. (canceled)

36. An apparatus comprising:
means for receiving a pickup request indication, wherein the pickup request indicates a request for pickup of a user by a vehicle at a pickup location;
means for receiving an arrival indication, wherein the arrival indication indicates the vehicle has arrived for the pickup;
means for, in response to the arrival indication, determining location information of the vehicle; and
means for causing provision of the location information of the vehicle on a user device.

37-40. (canceled)

41. The apparatus according to claim 36, further comprising:
means for generating a key associated with the pickup request; and
means for causing the vehicle to communicate the key.

42. The apparatus according to claim 41, further comprising:
means for causing the vehicle to flash light in at least one of a pattern or color associated with the key and the pickup request.

43-46. (canceled)
